(19) United States
(12) Patent Application Publication
(10) Pub. No.: US 2002/0103809 A1
(43) Pub. Date: Aug. 1, 2002

(54) Combinatorial query generating system and method

(75) Inventors: Timothy W. Starzl, Boulder, CO (US); Ravi S. Starzl, Boulder, CO (US)

Correspondence Address: MERCHANT & GOULD PC, P.O. BOX 2903, MINNEAPOLIS, MN, 55402-0903, US

(73) Assignee: SearchLogic.com Corporation

(21) Appl. No.: 09/776,161

(22) Filed: Feb. 2, 2001

Related U.S. Application Data
(63) Continuation-in-part of application No. 09/715,540, filed on Nov. 17, 2000.
(60) Provisional application No. 60/179,744, filed on Feb. 2, 2000.

(51) Int. Cl. G06F 7/00

(52) U.S. Cl. 707/102

(57) ABSTRACT

An automated system and method for creating a topical data structure of documents or other items from an inter-linked system of documents, such as the Web and/or the Internet. The data structure can then be searched using conventional means information to generate highly relevant results. The system automatically utilizes pre-existing search resources to discover and collect topically relevant information from the inter-linked system of documents, which can be added to the topical data structure. The topically relevant information collected using the pre-existing search resources can be directly added to the data structure or can be further filtered for relevancy before being added to the data structure.

### RELATED APPLICATIONS

This application is a continuation-in-part of U.S. patent application Ser. No. 09/715,540, entitled METHOD AND SYSTEM FOR COLLECTING TOPICALLY RELATED RESOURCES, filed Nov. 17, 2000. This application also claims the benefit of, and hereby incorporates by reference, U.S. Provisional Application 60/179,744 entitled COMBINATORIAL QUERY GENERATING SYSTEM, filed Feb. 2, 2000.

### TECHNICAL FIELD OF THE INVENTION

The present invention relates to processes for discovering and collecting information located in an inter-linked environment such as the Internet and the World Wide Web (“Web”) or in other archived, repository, database or stored information environment where the information is in a digital format, and is accessible electronically. More specifically, the present invention relates to improving both the topical or class relevancy of the information collected and the amount of relevant information collected from these environments. More specifically still, the present invention relates to generating query combinations that are supplied to existing database environments to increase the number of relevant results.

### BACKGROUND OF THE INVENTION

The World Wide Web is an extremely large, inter-networked data system connecting hundreds of millions of informational sites and documents and is growing daily. The inter-linked relationships between these sites create a dynamic system of enormous complexity. Despite the information or “content” dependent utility of the Web, the existing Internet addressing system does not locate or identify sites based on their information content. Thus, one of the persistent problems associated with the Web is finding useful information. Indeed, while the rich, decentralized, dynamic and diverse nature of the Web can make casual Web surfing enjoyable, it has made serious navigation aimed at finding specific information extremely difficult.

In response to this problem, several types of Internet/Web navigation, location, finding or searching resources have evolved in an attempt to facilitate the presentation of sites based on content. One such resource relates to an automated information retrieval system, often referred to as an Internet or Web “search engine.” Typical search engine systems involve at least two specific components. First, typical search engines have a database creation component that uses automated collection agents, i.e., software programs generally called “spiders,” to automatically traverse the Web to discover and collect accessible information source items independent of content. The term spider is understood here to include automated user agents, call utilities, Web robots, bots, autonomous and mobile agents dedicated to the function of automatically retrieving documents, pages, or resources either by traversing the web or by some other means. In essence, spiders automatically traverse the Web's hypertext link structure, recursively retrieving documents, pages, or resources that are discovered and return these items, e.g., Web documents or document addresses (URLs) to populate a confined data structure.

Second, typical search engines provide a query function or component that allows an end-user to access the populated data structure and query that data structure to retrieve resource items based on content, i.e., content related to the supplied query. This second component is referred to herein as an Information Retrieval System, wherein the term “Information Retrieval System” or “IR system” refers to the data structure-based functions of storage, ordering, and presenting of previously discovered and collected information, as distinct from the processes of discovery and collection of data from the Web. Thus, using an IR system that has been populated with resource items through the use of a spider, end-users may supply queries to the database and, although all of the web pages that the spider discovers and collects are stored in an undifferentiated manner, the IR system can present items that generally relate to the query to the end-user.

One particular drawback associated with typical search engines relates to the fact that since the data structure portion of the IR system is populated with many items that have not been filtered for content, the results of an end-user query generally have a significant number of irrelevant items. One response to the lack of relevancy in search engine results has been the development of “Web directories.” These directories consist of manually created databases (as compared to the automatically created databases of IR systems). People examine each page or resource and determine whether the resource should be included in the directory's database. Web directories are distinguished from search engines in that they only collect or accept content that is relevant to a topic or category within the directory. Although each directory typically has highly relevant resources, the throughput of manual processing creates directory databases that are unsatisfactorily small, on the scale both of the total Web and when compared to the size of Web search engine IR system databases. Moreover, since people must manually perform the task of accepting or rejecting each and every resource, the cost of maintaining and updating the directories is significantly high.

With respect to either search engines or Web directories, an end-user supplies a query, or search criteria, in order to access information contained in a search engine IR system database or a directory database. Typically both search engines and directories give greater weight to the keywords or phrases occurring at the beginning of a query, the order of the keywords or phrases may critically impact the amount of relevant information returned. For example if a user was attempting to get information about his Volkswagen Golf automobile, the query “Golf and Volkswagen” may return two hundred sites dealing with the game of golf, but none dealing with automobiles. Conversely, the query “Volkswagen and Golf” may return one hundred sites dealing with automobiles, but still return one hundred, irrelevant sites, dealing with the game of golf. The problem becomes worse when more keywords are added to the query. Therefore, a major problem with current search techniques is that even if a user manually inputs every combination of keywords in an attempt to retrieve relevant sites, the process may still present many irrelevant sites.

The primary reason for the presentation of irrelevant data relates to the limitations of the search engine's IR system. (As mentioned above, directories usually contain relevant information, but the amount of relevant information is small due to manual processing.) Although it would be desirable for an IR system to contain every document available by using an “unconstrained” spider, such spidering is impractical. In principle the entire Web can be discovered and gathered using an unconstrained spider, however, in practice the process is intractable, and system resources are rapidly used up. For instance if a spider conducts a long unconstrained traversal, a large amount of memory resources are required to store the large amount of returned results. Problems associated with practical spidering of the Web include the large and highly variable number of links on different pages, the high level of self-referential and recursive linking architectures, and cyclical link paths. Furthermore, spiders do not differentiate documents based on topical content. Instead, each document that is traversed is returned to the database, creating a large, undifferentiated collection of items.

As mentioned above, if the search engine's spider is allowed to conduct an unconstrained search, an extremely large amount of information (both relevant and irrelevant) is retrieved and system memory is consumed quickly. Because IR systems have a limited memory capacity, a significant portion of the Web is left untouched by the search engines, and as a result, relevant information remains undiscovered by the user.

If possible, search engine and directory providers would like to populate their IR system and directory databases with every bit of available information. However, search engine and directory providers must balance the desire to construct such large databases with the limitations imposed by system resources. Each provider may take a different approach to achieve this balance. As a result, each IR system and directory database may be of a different size, may be populated with different information, and may present the information to the user in different ways. Therefore, a query search entered on one search engine or directory may return different results than if the same query search was entered into a second search engine or directory. Ideally, a user would like to take advantage of the different methods for gathering, storing, and retrieving data used by each search engine or directory. Unfortunately however, a user must typically enter each query combination into each search engine and/or directory. Furthermore, a user is required to manually filter all of the irrelevant items returned from each search engine and/or directory.

Additionally, typical search engines only provide a limited number of responses to a particular query. For example, many search engines only provide a user two hundred resources in response to a single query. The reason for the limited number of responses relates to the fact that a single user is typically unable to review hundreds or thousands of different resources that may potentially be returned in response to a query. Moreover, search engines typically have different relevancy rankings from other search engines according to predetermined criteria. Consequently, the same search on different search engines often produces different results. Thus, in order to increase the number of relevant results, multiple queries should be performed on multiple search engines.

It is with respect to these considerations and others that the current invention has been made.

### SUMMARY OF THE INVENTION

The present invention relates to an automated system and method for creating a topical data structure, which can then be searched using conventional IR means. The term “topical” relates to the concepts of human-derived topic, class, category, grouping, natural grouping, taxonomic grouping, taxon, theme, cluster, or subject, and which may be identified through measures of relatedness, similarity, likeness, clustering, nearness, or other like measures. Since the data structure is topical, i.e., primarily restricted to topically related information, the results from the search show substantially improved query relevancy. Additionally, since the discovery and collection system is automated many more documents can be incorporated into the data structure, and the cost of generating and updating the data structure is relatively low. Additionally, the present invention relates to the creation of many queries in response to singular supplied query.

In accordance with preferred aspects, the present invention relates to a system or method for discovering and collecting information from an inter-linked system of documents, such as the Web and/or the Internet. The system or method accepts a search criteria query and generates a matrix of the query's keywords or keyphrases. These keywords and keyphrases are automatically loaded into a query server. This query server utilizes many pre-existing Internet search resources (e.g., search engines, directories, streams, etc.) to locate web documents matching the search criteria. These web documents may be actual textual documents, images, pages, or other resources found on the Web, as well as their addresses. The system creates a crawl table by parsing, storing and de-duplicating the located web documents returned from the pre-existing Internet search resources. The system then uses a spider server to retrieve, from the Internet, the full-text document related to each item in the crawl table. The system analyzes each document retrieved to extract a document signature, wherein the signature is related to the content of the document, and then compares the signature for each document to predetermined signature criteria related to that topic to determine the relevancy of each document to that topic. The system adds or combines sufficiently relevant documents to create a topical data structure. The analysis and comparison is done by a filter system that may be either external or internal to an information retrieval system where the topical data structure resides.

In accordance with other aspects, an autoloader is used to either directly or indirectly connect to access the query server. Additionally, more than one filter may be used to determine the relevancy of each document retrieved by second spider server. This information can then be further evaluated to determine whether additional analysis is necessary in determining whether to include or reject a document from the topical data structure.

The predetermined signature criteria may be derived from a collection of sample documents to determine topical signatures and preferably using some form of analysis, such as lexical, relational, statistical, linguistic, or inferential content analysis. The constrained results produced may subsequently be used in any IR system, such as a document search engine, a hierarchical directory, a vector space construct, any clustering algorithm driven data structure, array or construct, or any data storage and query format.

The invention may be implemented as a computer process, a computing system or as an article of manufacture such as a computer program product. The computer program product may be a computer storage medium readable by a computer system and encoding a computer program of instructions for executing a computer process. The computer program product may also be a propagated signal on a carrier readable by a computing system and encoding a computer program of instructions for executing a computer process.

The query generating system and method adds new keyterms based on a received initial query. The process of adding keyterms may be through the use of thesaurus keyterms, stemming or duplication. With respect to the use of thesaurus keyterms, synonyms may be added automatically from a lookup table or the process may provide a list of possible thesaurus keyterms for selection. In such a case, only selected synonyms are added to the query.

Once the keyterms have been added, syntactical variations may be employed to increase the number of possible queries in the matrix. Syntactical variations may be made based on case sensitivity, wild cards, keyterm order, Boolean relations, proximity relations and/or parenthetical nesting. Following the addition of keywords and the syntactical variations, the process enumerates the possible permutations to create the query matrix. One method of enumerating the permutations involves creating a template text document; assigning each keyword of then input query to an element of the template document; and performing a search and replace function on the template document with the keyword elements.

Following the syntactical variations, logical restrictions may be applied to limit the number of queries to a meaningful number of queries. The restrictions may be based on predetermined criteria, such as rules relating to ill-formed queries, the explicit use of operators or rules based on the sensitivity of a given search engine.

A more complete appreciation of the present invention and its improvements can be obtained by reference to the accompanying drawings, which are briefly summarized below, to the following detail description of presently preferred embodiments of the invention, and to the appended claims.

### BRIEF DESCRIPTION OF THE FIGURES

FIG. 1 is a block diagram of the computer system shown in FIG. 2 connected to server computers through a computer network.

FIG. 2 is a block diagram of a computer system that may be used to implement a method and apparatus embodying the improved collection system the present invention.

FIG. 3 illustrates the functional components of a Web discovery and collection system of the present invention.

FIG. 4 is a flowchart illustrating the operational characteristics of an embodiment of the invention.

FIG. 5 is a flowchart illustrating the operational characteristics of an embodiment of the invention.

FIG. 6 is a flowchart illustrating the operational characteristics of an embodiment of the invention.

FIG. 7 is a flowchart illustrating the operational characteristics related to the combinatorial matrix generation process.

FIG. 8 is a flowchart illustrating the operational characteristics related to enumerating permutations of a keyterms in a query during generation of a query matrix.

### DETAILED DESCRIPTION OF THE INVENTION

The logical operations of the various embodiments of the present invention are implemented (1) as a sequence of computer implemented steps or program modules running on a computing system and/or (2) as interconnected hardware or logic modules within the computing system. The implementation is a matter of choice dependent on the performance requirements of the computing system implementing the invention. Accordingly, the logical operations making up the embodiments of the present invention described herein are referred to alternatively as operations, steps or modules.

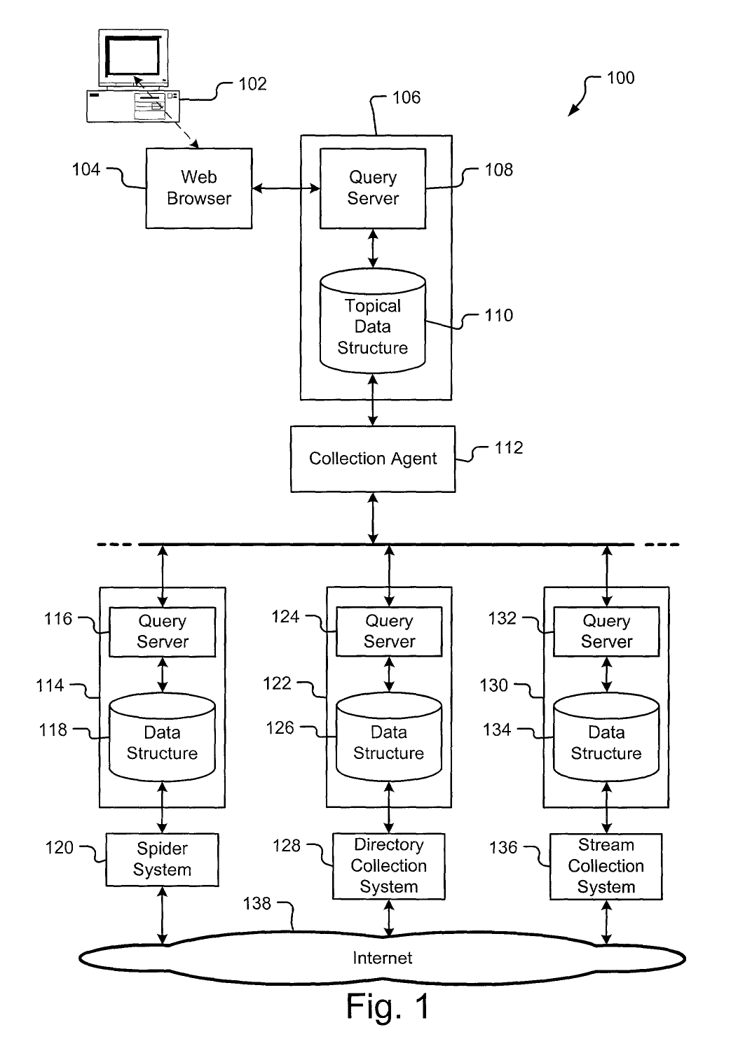

An interconnected computer system 100 that may incorporate aspects of the present invention is shown in FIG. 1. The client computer system 102 operates a traditional browser application 104. The browser application 104 communicates with an information retrieval system 106, which is located on either computer system 102 or on another server computer system (not shown). The retrieval system 106 comprises a suitable query server 1 08 and a topical data structure 110, preferably a database or text base. The topical data structure 110 of the information retrieval system 106 is populated by a collection agent 112.

The collection agent 112 queries pre-existing search resources or queriable databases, which generally comprise links to informational sites that are linked via the hypertext transfer protocol (HTTP). That is, “queriable databases” as used herein relates to data structures that may be searched using a query and may include such items as databases, text bases, or other data structures. Each of the sites resides on a server computer system (not shown) that collectively make up an interconnected network such as the Internet or World Wide Web as shown in FIG. 1. In an embodiment, the collection agent 112 collects information from multiple search resources 114, 122, 130 which are located on either computer system 102 or on other server computer systems (not shown). Search resources include typical search engines 114, directories 122, and information streams 130.

Each search resource 114, 122, 130 comprises a suitable query server 116, 124, 132 and a data structure 118, 126, 134 preferably a database or text base. In an embodiment, the search engine 114 communicates with spider systems 120, which traverses the Internet 138 and collects information. Likewise, the directory 122 communicates with a directory collection system 128 and data stream 130 communicates with a stream collection system 136, which traverse the Internet 138 to collect information. The spider system 120 stores the collected information in the data structure 118. Likewise, the directory collection system 128 stores the collected information in data structure 126 and the stream collection system 136 stores the collected information in data structure 134. The query servers 116, 122, 130 receive one or more queries from the collection agent 112 and use the provided one or more queries to search the data structures 118, 126, 134 for potentially relevant information. Once the potentially relevant information is retrieved, that information is then presented to the collection agent 112, which filters out irrelevant or duplicate information, and stores the remaining relevant information in the topical data structure 110. The topical data structure 110 stores the relevant information, and may be configured to index or otherwise sort the information for future reference.

The query server 108 receives a query from the browser 104 and uses the query to search the topical data structure 110 for information related to specific user queries. Once the highly relevant information is retrieved, that information is then presented to a user of computer 102 through the interface that is displayed through the browser 104.

In one embodiment of the invention, the computer 102 is a desktop computer system. In alternative embodiments, the invention is used in combination with any number of other computer systems or environments, such as in handheld computer environments, laptop or notebook computer systems, multiprocessor systems, micro-processor based or programmable consumer electronics, network PCs, mini computers, main frame computers and the like. The invention may also be practiced in distributed computing environments where tasks are performed by remote processing devices that are linked through a communications network in a distributed computing environment, programs may be located in both local and remote memory storage devices.

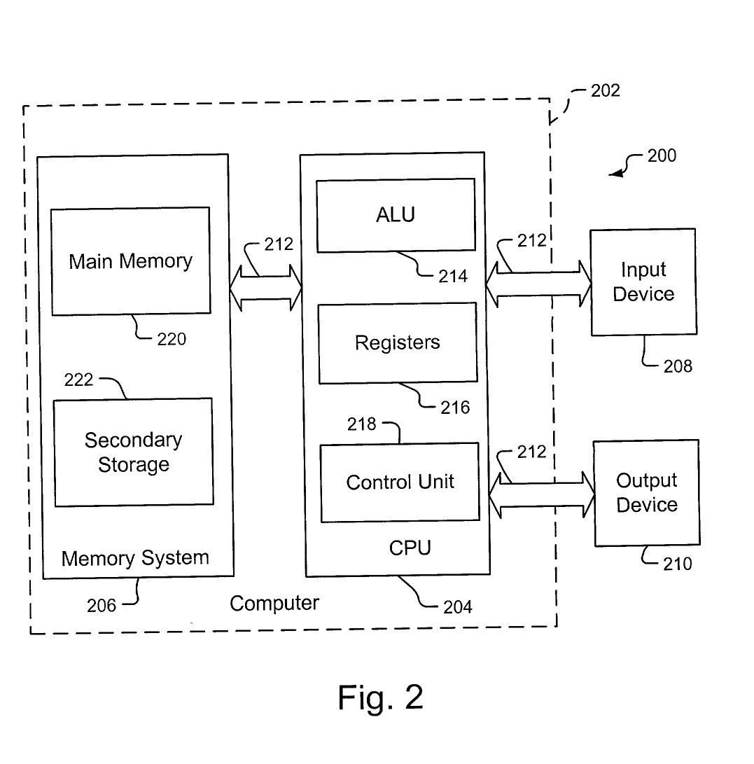

The computer 102 incorporates a system of resources for implementing an embodiment of the invention, such as the system 200 shown in FIG. 2. The system 200 incorporates a computer 202 having at least one central processing unit (CPU) 204, a memory system 206, an input device 208, and an output device 210. These elements are coupled by at least one system bus 212.

The CPU 204 is of familiar design and includes an Arithmetic Logic Unit (ALU) 214 for performing computations, a collection of registers 216 for temporary storage of data and instructions, and a control unit 218 for controlling operation of the system 200. The CPU 204 may be a microprocessor having any of a variety of architectures including, but not limited to those architectures currently produced by Intel, Cyrix, AMD, IBM and Motorola.

The system memory 206 comprises a main memory 220, in the form of media such as random access memory (RAM) and read only memory (ROM), and may incorporate or be adapted to connect to secondary storage 222 in the form of long term storage mediums such as hard disks, floppy disks, tape, compact disks (CDs), flash memory, etc. and other devices that store data using electrical, magnetic, optical or other recording media. The main memory 220 may also comprise video display memory for displaying images through the output device 208. The memory can comprise a variety of alternative components having a variety of storage capacities such as magnetic cassettes memory cards, video digital disks, Bernoulli cartridges, random access memories, read only memories and the like may also be used in the exemplary operating environment. Memory devices within the memory system and their associated computer readable media provide non-volatile storage of computer readable instructions, data structures, programs and other data for the computer system.

The system bus 212 may be any of several types of bus structures such as a memory bus, a peripheral bus or a local bus using any of a variety of bus architectures.

The input and output devices are also familiar. The input device can comprise a small keyboard, a mouse, a microphone, a touch pad, a touch screen, etc. The output device can comprise a display, a printer, a speaker, a touch screen, etc. Some devices, such as a network interface or a modem can be used as input and/or output devices. The input and output devices are connected to the computer through system buses 212.

The computer system 200 further comprises an operating system and usually one or more application programs. The operating system comprises a set of programs that control the operation of the system 200, control the allocation of resources, provide a graphical user interface to the user, facilitate access to local or remote information, and may also include certain utility programs such as the email system. An application program is software that runs on top of the operating system software and uses computer resources made available through the operating system to perform application specific tasks desired by the user. In general, applications are responsible for generating displays in accordance with the present invention, but the invention may be integrated into the operating system.

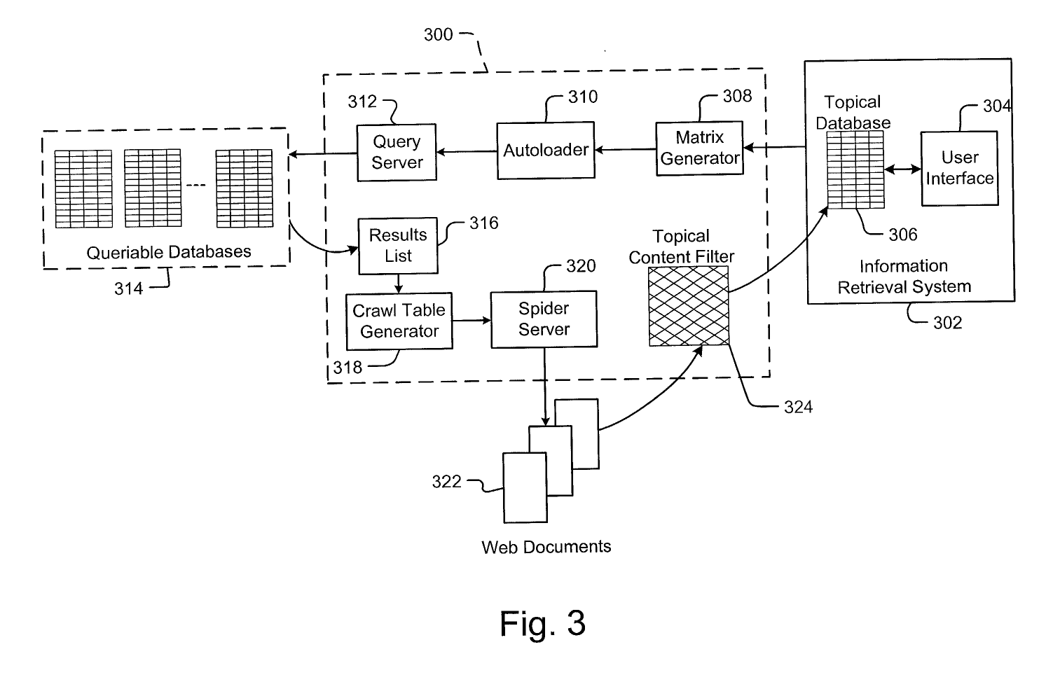

An embodiment of the present invention is shown in FIG. 3. In this embodiment, the information retrieval system 302, which is similar to informational retrieval system 106 (FIG. 1), communicates with a collection and filtering system 300. More specifically, the information retrieval system 302 sends a query to matrix generator 308. The matrix generator 308, combines query keywords and phrases or other parameters (such as graphics or document dates) into combinations of conjunctions, conjunctions and disjunctions, disjunctions, or other operations and creates a matrix of the results. For example if a user enters a query having keywords A, B, and C, the generator may be instructed to create a matrix with the following combinations ABC, ACB, BAC, BCA, CAB, CBA, AB, AC, BA, BC, CA, CB, A, B, and C. The location of a keyword in a query is important because most Internet search engines and directories place greater weight on the terms positioned at the beginning of the query. For example in the combination AC, keyword A is given priority over keyword C, and therefore, the results returned will more likely contain keyword A and may skip some documents with keyword C. Keyword C, on the other hand, is given priority in combination CA, and therefore, the results returned will more likely contain keyword C and may skip some documents with keyword A.

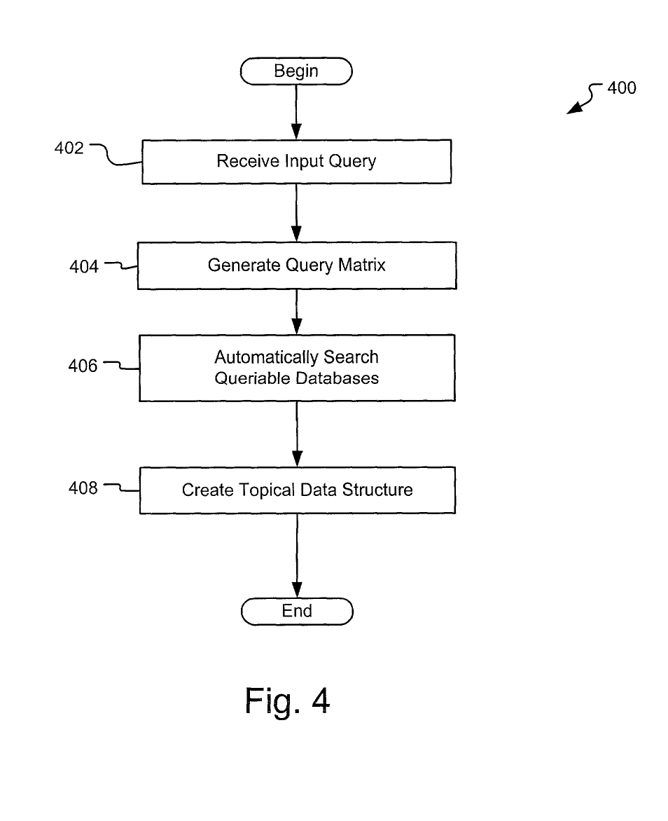

The use of matrix generator 308 in the present invention insures that the greatest amount of information that may be relevant to a user's query is captured for analysis. Matrix generation may be completed by either manual or automatic methods. The rules for the matrix generator may be embedded in particular versions of the matrix generator, or alternatively, may be user-specified. Importantly, the generated query set need produce more than one query, wherein each query relates to different aspects of a predetermined topic or describe the same aspect using different key terms or combinations of terms. More details of the matrix query generator are discussed below in conjunction with FIGS. 4 and 7-8.

The matrix generator 308 transmits the combinations of keywords and phrases, i.e., the set of queries to an autoloader 310. Although shown and described as using a matrix generator to supply multiple queries to the autoloader 310, in alternative embodiments, a set of queries may be manually provided to the autoloader 310, thereby eliminating the need for an automatic generation of more than one query. The autoloader 310 queues each of the combinations for submission to a query server 312. The autoloader 310 can be any software or system capable of inputting an element or elements of the matrix or some other list, table, group, etc. into another program or system (here query server 312) without requiring manual intervention. The autoloader can control the rate and order of the submissions made to query server 312.

Query server 312 queries Internet search resources (such as ALTA VISTA, LYCOS, HOTBOT, EXCITE, SNAP, and YAHOO among others) to search queriable databases 314. Query server 312 is any software program or system capable of communicating with a queriable database by submitting a query and returning the results. Queriable databases relate to data structures that may be searched using a query and may include such items as databases, text bases, or other data structures. Additionally, a queriable database may include any system that has one or more of the following: a user or machine interface where a query can be entered; a database of Internet accessible information; a spider or collection system to search the Internet. In addition, a queriable database may include any system that does one or more of the following: finds the best matches to the user query from its database using either simple keyword matching or a more advanced algorithm; keeps an index or record of any results that it finds; and presents the index or record of results in response to the entered query. The queriable database responds to the query server 312 by returning a list of documents (documents may be actual textual documents, images, pages, or other resources found on the Web or in a database, as well as their addresses) that relate to the query criteria. The list of related documents is returned to a results table. The list may be parsed, stored, and de-duplicated in order to construct a results list 316.

The information in the results list 316 may be used by a crawl table generator 318, which manipulates the results list to create a crawl table that lists sites, locations, documents, etc. for use as a traversing guide by spider server 320. Spider server 320 uses the resulting crawl table produced by crawl table generator 318 and traverses the selected web documents 322. Spider server 320 retrieves the full-text of the selected documents 322 listed in the crawl table.

The collection agent 300 may also use a topical filter 324. The topical filter 324 analyzes the full-text pages returned by spider server 320 and accepts or rejects each document based on predetermined topical content criteria. The collection agent retrieves relevant information using differentiating “linguistic signatures,” i.e., a linguistic or lexical signature that relates to any extractable attribute or representation of content, or subject matter, that provides a basis for document or subject recognition or differentiation and usually beyond that provided by the simple presence or absence of a keyword, a group of keywords, or Boolean expression. Designed constructs of keywords representing a subject or topic may be extracted or generated that reflect this equivalent function. Additionally, differentiation of discovered material by comparison to a linguistic signature or template, may be topically or categorically related by a predefined linguistic, lexical, textual, semantic, syntactic, mythographic, semiotic, pictographic, hieroglyphic, graphic, structural, hybrid or other content related attributes.

The ability to differentiate, select or reject a document on the basis of its content requires the use of topical signature data for differentiation. The discovery or development of this signature refers to any of a class of processes for the mathematical, logical, or linguistic extraction and characterization of document, atomic, molecular or elemental components (words, lexies, associative patterns, frequencies, word clusters, word class relationships, etc.) to produce a set of differentiating representations or characteristics. These representations are referred to as “linguistic signatures” in this disclosure. The methods referenced here include: lexical analysis, semantic analysis, syntactical analysis, textual analysis, clustering analysis, auto-categorization, vector analysis, statistical analysis, heuristics, pragmatic methods and/or any models, algorithms or relationships using these methods. Also included within a definition of the system is the application of a linguistic signature, derived or extracted by any means, by the filter 324 as a conformity test for unknown, heterogeneous documents.

Differentiation by “linguistic signature” according to subject matter of a web document is to be understood as the automated assignment of document membership or the identification of non-membership within a pre-defined subject, category, class, or topic area. Acceptance, differentiation or rejection may be into, or in reference to, any topical, subject, categorical, hierarchical, relational or other organizational system, scheme, ontology, taxonomy, or concept hierarchy, using any relatedness-based classification measure or method.

A class, category, subject or topic may be identified by human judgment or agency, or may be identified as a measure of relatedness, similarity, or clustering of a group of documents. A class, category, subject or topic “linguistic signature” may be determined in substantially the same manner as described above for the determination of document “linguistic signature” as applied over a sufficiently large group of documents judged to be members of the class, category, subject or topic so as to allow for the creation of a representative signature. The method includes any method for the development or identification of lists, strings, arrays, files, algorithms, expressions, collections or groupings of such elements that are characteristic of the subject class, category, subject or topic.

The content accepted by topical content filter 324 is then transmitted to the database 308 of the IR system of topical information, however, by using the present invention, a more topically relevant database will be created because the keyword and phrase matrix generator permits a more in-depth analysis of existing databases. Furthermore, the database will be created in a faster and more efficient manner because the autoloader eliminates the need for manual entry of keyword and phrase combinations created by the matrix generator.

The database 308 may then be searched by an end user via user interface module 304. That is, a user interested in finding items on the Internet, in one example, may enter search terms into the user interface module 304 which, in turn, searches the topical database 308 and presents the results to the user through module 304. In an alternative embodiment, the user interface module 304 may be used to provide a first query to the collection 300. Additionally, in this alternative embodiment, the collection agent 300 queries multiple queriable databases, using a query set and presents the results to the user through the interface module 304. In essence, the user would use the collection agent 300 to conduct a topically filtered meta search which may or may not incorporate the use of a confined data structure 308.

FIG. 4 illustrates the operation flow process 400 that relates to an embodiment of the present invention. Process 400 begins with receive input query operation 402 which accepts user or machine generated keywords or keyphrases that relate to the topic the user desires to search. Single or multiple keywords and/or phrases can be received.

Once the keywords and/or phrases are received, generate query matrix operation 404 assumes control. In this operation, the query keywords and phrases are combined into combinations of conjunctions, conjunctions and disjunctions, disjunctions, or other operations embedded in particular versions of the matrix generator, or alternatively, specified by the user. Operation 404 insures that the greatest amount of information that may be relevant to a user's query can be captured for analysis. Operation 404 may be completed by either manual or automatic methods. In essence a set of queries is generated wherein each query describes or relates to a different aspect of the topic or provides a different approach to the same aspect of the topic. Moreover, the set of queries may involve limited elements. For example, a query set may include the key terms “Black Dog” for one element of the set and “White Dog” for the other element of the set. The two set elements may be kept separate from each other instead of combining the two elements into one query, such as in the query, “Black Dog” OR “White Dog”. Although the two queries may be equal from a Boolean standpoint, maintaining the elements as separate queries provides improved results in some cases since two queries typically provide more overall results than one. That is, since some search resources provide only 200 items in response to a query, the previous example incorporating a query set of two elements would glean 400 items, as opposed to only 200 items retrieved for its Boolean equivalent of one query.

The results of generate query matrix operation 404 are used by operation 406, which automatically searches a queriable databases. Operation 406 utilizes pre-existing search resources (search engines, directories, and streams, among others) to complete the search. In one embodiment the pre-existing search resource relates to the recursive topical search spider described in co-pending U.S. patent application Ser. No. 09/565,933, titled METHOD AND SYSTEM FOR CREATING A TOPICAL DATA STRUCTURE, filed May 5, 2000, incorporated herein by this reference for all that it discloses and teaches, and which is assigned to the Assignee of the present application. The sources discovered and collected by this process may be incorporated into any conventional information retrieval system, may be subject to further processing, ordering, characterization, or organization, and may be presented as either a directory hierarchy or as a searchable data structure.

Operation 408 accepts the results obtained by operation 406 and creates a topical data structure. This data structure may be indexed or sorted, as may be the case in where the data structure is a component of an information retrieval system. Once the data structure has been populated with topically related information, the information can be accessed through conventional means such as through the use of an informational retrieval system. However, since only topically related information exists in the database, the system is more likely to produce information relevant to the specific query. Also since the database does not contain a significantly large amount of irrelevant data, a larger amount of topically related data will inhabit the database, thereby allowing the results of query searches to be more complete as well. That is, since the invention allows for the discovery and inclusion of defined subsets of resources, differentiated from other unrelated resources, in an automated or semi-automated manner, a high relevancy resource is generated. Because the system is automated, the depth or completeness achieved by this system can be as great or greater than provided by a typical, prior-art Web directory approach.

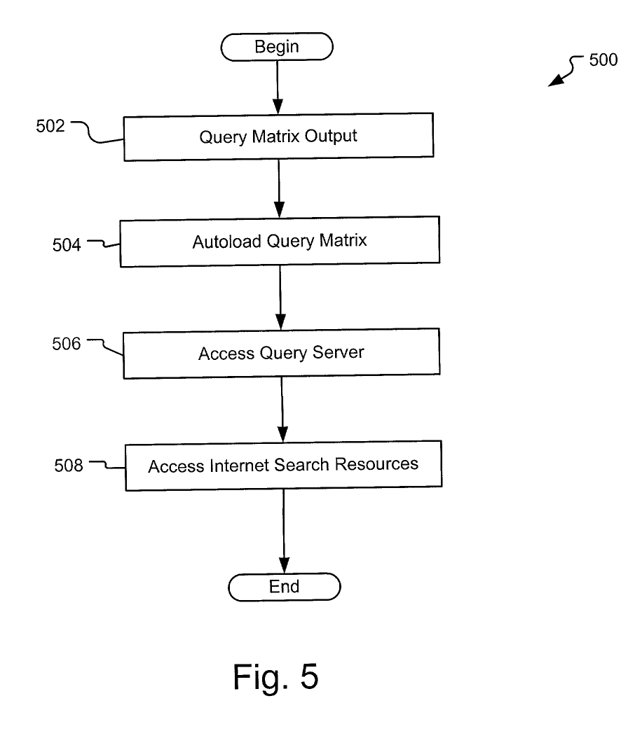

FIG. 5 illustrates an embodiment of automatically search queriable databases operation 406. Process 500 begins with query matrix output operation 502 which transmits or makes available user or machine generated keywords or keyphrases that relate to the topic the user desires to search. Single or multiple keywords and/or phrases can be received.

The results of generate query matrix operation 502 are transmitted to, or retrieved by, autoload query matrix operation 504 which queues each of the query combinations and submits each query combination to access query server operation 506. The autoload query matrix operation 504 can be any software or system capable of inputting an element or elements of the matrix or some other list, table, group, etc. into another program, system, or operation (here, access query server operation 506) without manual intervention. The autoload query matrix operation 504 can control the rate and order of the submissions made to access query server operation 506.

Access query server operation 506 feeds the query combinations from autoload query matrix operation 504 to operation 508, the access Internet search resources operation. Access query server operation 506 can be any software program or system capable of communicating with a queriable database by submitting a query and retrieving the results.

Access Internet search resource operation 508 utilizes existing search resources (such as search engines, directories, and streams among others) to search and retrieve web documents matching the input query. A web document may be textual documents, images, pages, or other resources found on the Web, or merely an address or link to such text, image, page or resource. A search resource (such as ALTA VISTA, LYCOS, HOTBOT, EXCITE, SNAP, and YAHOO among others) can include any program or system that has or does one of the following: a user interface where a query can be entered; a database of internet accessible information; a system to search the whole Internet or any portion thereof; finds the best matches to the user query from its database using a proprietary relevancy algorithm or through simple keyword matching; keeps an index or record of any results that it finds; and permits a user to examine the index or record of results. The documents retrieved by access Internet search resources 508 may be used to create a topical data structure, a results table or a results list.

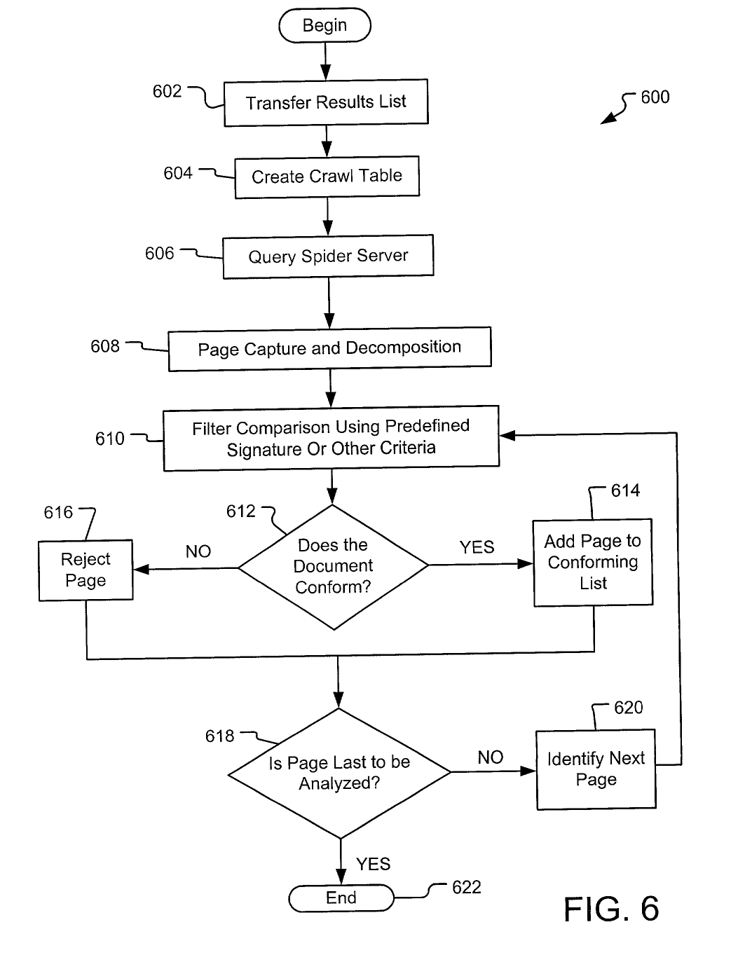

FIG. 6 illustrates the operational flow process 600 that relates to the preferred embodiment of the present invention that uses the results list or results table produced by process 500 (see FIG. 5) to produce a topical data structure. Process 600 begins with transfer results list operation 602 transmitting or making available to create crawl table operation 604 the results from process 500. Create crawl table operation 604 retrieves or accepts the results stored in the results table and eliminates all duplicate result entries. For example, if both an image and a link to that image were found in the results table, operation 604 would remove one of those results so that only the image or the link to the image remains in the results list. Create crawl table operation 604 then stores the de-duplicated results in a crawl table.

Query spider server operation 606 uses a spider to retrieve or accept the results stored in the crawl table by operation 604. The spider of query spider server operation 606 traverses the web, visiting those sites identified in the crawl table. Once at the given site, page capture and decomposition operation 608 retrieves the document located at the site and parses the information. This operation may involve an in-depth lexical analysis, or other analysis of the document to extract a “signature” for the document. The signature is reflective of the subject matter or content of the document.

Next, operation 610 performs a comparison on the signature that has been generated by operation 608. The filtering operation 610 may be any method suitable for the comparison of the document “linguistic signature” to a pre-determined class, category, subject or topic “linguistic signature”, so as to determine within some specified level of precision, the membership of the subject document within the subject class. The method references any means suitable to allow a determination of whether a document falls within, or out of, a particular pre-specified class, topic, subject or category. In particular, in an embodiment of the present invention, the filtering operation 610 utilizes a linguistic signature to determine conformity of collected data sets to preexisting human-derived topic, category, class or subject cognitive criteria. For example, one use for this system is the automated production of an information resource similar to a content-based Web Directory.

The filtering step 610 may compare the document signature with a predefined signature to produce a weighted score related to the probable degree of relevance for the document. In order to determine a predefined signature, personnel responsible for the data structure may decide what topic(s) the data structure should include and what untargeted topic(s) may use language similar to that of the target topic(s). Using information related to the language of the targeted topic and not related to untargeted topics, a definition of the goals for the inclusion filters and exclusion filters for the topical data structure is generated. As an example, a topical database for the topic of golf, i.e., the game, may require the inclusion of documents having the word golf in them, unless they refer to cars named GOLF which are made by Volkswagen.

This process may involve the selection by the database collection personnel of one or more electronic texts as representative of the topic selected. These documents may be manually selected or automatically selected from a web directory or other search resource that can provide topically representative documents. A class, category, subject or topic may be identified by human judgment or agency, or may be identified as a measure of relatedness, similarity, or clustering of a group of documents. In addition, for some topics it may be important to select documents representative of the exclusions that are identified by the database personnel and to place these into separate corpora for analysis. Such topics and documents may use overlapping terminology but are not targeted by the topical database. Generally, more than one document will be required to form a corpus of documents for analysis. However, one document of sufficient length and topical specificity may also be used for the purpose of further analysis.

The topical document collections are then analyzed for a lexical signature. The ability to differentiate, select or reject a document based on its content requires the use of such signature data for differentiation. As described above, the discovery or development of this signature refers to any of a class of processes for the mathematical, logical, or linguistic extraction and characterization of document, atomic, molecular or elemental components (words, lexes, associative patterns, frequencies, word clusters, word class relationships, etc) to produce a set of differentiating representations or characteristics. Preferably, the sample documents are analyzed using some form of quantitative or semi-quantitative analysis beyond that provided by the simple presence or absence of a keyword, a group of keywords, or Boolean expressions that are derived by qualitative analysis of the topic by the database collection personnel. In addition, the relationships between words and non-lexical features of the document (graphics, encoding, hyperlinks) may also be analyzed for features of a signature.

A simple signature may be expressed as a simple list of keywords extracted from the representative document(s). In this case, it is preferable that a minimum of three keywords be used to provide the most basic data for a Boolean-logic-based filter for the presence or absence of keywords in any given document. Even under this simplest case, the previously mentioned quantitative and semi-quantitative methods should be employed to extract or assist in the extraction of meaningful lexical features of the signature.

The signature extraction process produces a series of features of the document. These features can then be applied within the topical filter. The filter process may involve application of the feature extraction process in reverse. However, the process for filter process does not have to be the same analysis as that used to extract the signature. For example, a keyword frequency analysis could be employed to extract the lexical signature and then those keywords could be employed in a Boolean filter, a co-association matrix, or may be extended using a semantic nearness function.

Not every type of extracted feature in a signature will be able to be employed in every type of possible topical filter. Therefore, if a particular type of topical filter is to be used, it is important to make sure the feature extraction method used will produce features that are compatible with the filter and vice versa. Moreover, more than one filter may be employed in this step of the process. An array of topical filters may be employed for document analysis for both the inclusion and exclusion of pages into the topical database. Additional topical filters may also generate lexical metrics about the pages at this step in the process to be associated with the document into the topical database. These additional topical filters need not necessarily be part of the acceptance/rejection of the document into the topical database.

Following the filtering operation 610, the process determines, at step 612, whether the document meets the requisite criteria to be accepted (included) or rejected (excluded). In one embodiment, the filtering step produces a topical relevancy score and operation 612 compares the topical relevancy score against a minimum threshold value. If the score for the document is above the minimum threshold value, the document is determined to meet the criteria. In such a case, flow branches YES and the document is added to the conforming list at add operation 614.

Once a document is added to the conforming list at 614, step 618 determines whether the document was the last document to be filtered (i.e., the last page retrieved by the spider server of operation 606). If the page is determined, at determination step 612 to not be the last page filtered, then flow branches to NO to identify next page operation 620, which finds the next page to be analyzed and passes it to operation 610 and the process continues. If the page is determined, at determination step 618 to be the last page filtered, then flow branches to YES and the process ends 622.

If the page is determined to not conform to the predetermined criteria at operation 612, such as when the score is below the minimum threshold, the process flow branches NO to reject page operation 616, which does not add the page to the conforming list.

If the page is determined, at determination step 618 to not be the last page to be filtered (i.e., the last page retrieved by the spider server of operation 606), then flow branches NO to identify next page operation 620 which identifies the next page to be analyzed and passes it to operation 610 and the process continues. If the page is determined, at determination step 618 to be the last page filtered, then flow branches to YES and the process ends 622.

In an embodiment of the invention, the conforming list created at operation 614 comprises the full-text page for all the items that are added to the topical database 306 (see FIG. 3). In an alternative embodiment, each time a page is determined to be conforming at step 612, the page is added to the list at 614, and is then forwarded to an additional processing module, (not shown). This module performs a more intensive analysis on the document, as opposed to merely comparing a signature for the document to a template. The full analysis may comprise lexie identification, grouping, correlation, pattern recognition, pattern matching, fitting and other analysis techniques. Following this analysis, the page is either determined to be in or out of topic. If it is out of topic, the page is rejected as described above at step 616 and flow branches to operation 618. If it is determined to be in topic, then the page is forwarded to the topical database. Additionally, the page may be forwarded to a topical hierarchy directory interface and potentially a learning engine of strategy level modeling or a neural network for pattern recognition.

Once the database has been populated with topically related information, the information retrieval system may operate in the conventional manner. However, since only topically related information exists in the database, the system is more likely to produce information relevant to the specific query. Also since the database does not contain a significantly large amount of irrelevant data, a larger amount of topically related data will inhabit the database, thereby allowing the results of query searches to be more complete as well. That is, since the invention allows for the discovery and inclusion of defined subsets of resources, differentiated from other unrelated resources, in an automated or semi-automated manner, a high relevancy resource is generated. Because the system is automated, the depth or completeness achieved by this system can be as great or greater than provided by a typical, prior-art Web directory approach. The sources discovered and collected by this process may be incorporated into any conventional information retrieval system, may be subject to further processing, ordering, characterization, or organization, and may be presented as either a directory hierarchy or as a searchable data structure.

In an embodiment of the invention, the query matrix generator 308 (FIG. 3) relates to a module that automatically generates multiple queries based on input query. As discussed above with respect to FIG. 4, the query matrix generator may create the multiple queries by rearranging the keywords and or modifying the word into conjunctions or disjunctions. In essence, there are many types of modifications that may be applied to a single input query of keywords or keyterms to create numerous queries that are designed to extract more relevant resources than would be extracted by using only the one query. At times, the different possible ways of modifying a query are referred to different “axes” along which the query may be modified. The different types of modifications may be broken down into keyword addition methods which extend the string of keywords that may be used in querying and syntax variation rules which are applied to the extended string of keyterms in ways that search engines are sensitive.

The following table (Table 1) summarizes a list of some of the possible axes, methods or ways in which a single query may be modified. Table 1 further provides example queries to illustrate the application of each method. For the purposes of these examples, assume the initial query is “golf club.”

TABLE 1

| Name of Method | Affect on Query | Example Queries |
|---|---|---|
| Key Term | Adds key terms that are | golf golf club |
| Duplication | similar to existing key terms. | golf club club |
| Thesaurus Synonym | Adds keyterms related to | golf resort |
| Addition | thesaurus synonyms. | golf association |
| Key Term Addition | Adds key terms based on | golfing club |
| based on Stemming | relatively standard suffix and | golf clubs |
| | prefix assignment rules. | golfs clubs |
| Case Sensitivity | Adds key terms with | Golf club |
| | different case properties. | golf Club |
| Keyterm Order | Modifies the location of | club golf |
| | keyterms within the query | |
| Boolean (Logical) | Boolean terms are modified | golf AND club |
| and Proximity | or proximity terms are used. | golf or club |
| Relations | | golf NEAR club |
| Parenthetical | Parenthesis or quotes may be | golf AND (club |
| Nesting | used to modify the query. | or association) |
| Wildcards | Wildcards may be used to | golf* club* |
| | increase the search results. | |

As shown in Table 1, to expand the search potential for a given initial query, related terms may be added to the list of keyterms. The words may be added according to many different algorithms, such as duplication, thesaurus synonym addition and/or “stemming.” With respect to thesaurus synonyms, a lookup table may be used to automatically insert synonyms. In alternative embodiments, the user may select appropriate synonyms for the given query from a list of synonyms. Choosing from a list may provide more relevant results since many words may have alternative meanings and thus may correspond to terms that are technically synonyms but which may be irrelevant for the present query.

Stemming relates to possible truncation of a keyterm and then the application of prefixes or suffixes to the root of the word to generate related words. For example, by applying stemming rules to the keyterm “production,” the root “produce” could be extracted and variants including “reproduction,” “productivity,” and “producing,” among others may be generated. Each new keyterm may be added to the list of keyterms or used to replace an existing keyterm.

As shown in Table 1, the present invention may also generate, given a list of keyterms, queries embodying possible variations along a number of syntactical dimensions, such as case sensitivity, keyterm order, Boolean (logical) and proximity relations, parenthetical nesting, wildcards, and repetition. Case sensitivity modifies the case of the predetermined letters in the various keyterms while keyterm order relates to the arrangement order of the various terms, as shown in Table 1.

Boolean or Logical and Proximity relations modifications relate to the operators used within a query of keyterms. Typical Boolean operators include “AND,” “OR,” and “NOT.” When the operator AND is used between a first term and a second term, the query searches for resources having the first term and the second term such that the query returns resources having only both terms. When the operator OR is used between a first term and a second term, the query searches for resources having the first term or the second term, such that the query returns resources having only one of the two terms but not resources having both terms. When the operator NOT is used between a first term and a second term, the query searches for resources having the first term but not the second term such that the query returns resources having the first term only and rejects items that include the second term. Proximity relations relates to operators such as “NEAR.” When the operator NEAR is used between a first term and a second term, the query searches for and returns resources having both terms located in close proximity to each other, e.g., within a predefined number of words or lines.

Parenthetical nesting may be used in combination with Boolean operators to produce additional search novelty. By simply rearranging parentheses, queries containing Boolean operators may produce varying results. For example, the query “(dog AND sled) OR Manitoba” will return only those resources on which both “dog” and “sled” appear or on which “Manitoba” appears. Alternatively, the query “dog AND (sled OR Manitoba)” will return resources on which both “dog” and “sled” appear or on which both “dog” and “Manitoba” appear.

Wildcards may also be used to increase search results. Keyterms consisting of character strings identified as partial words may be appended with a wildcard character such as an asterisk as a suffix (and/or prefix). If the wildcard is used as a suffix, then the query identifies resources having words beginning with the character string. In the case where the wildcard is used as a prefix, then the query identifies resources having words ending with the character string. In the case where the wildcard is used as a prefix and a suffix, then the query identifies resources having words containing the character string.

Additionally, repetition may be used to modify an initial query by adding duplicative keyterms. As relevancy may increase with multiple words, even if duplicative, such a method may produce different results.

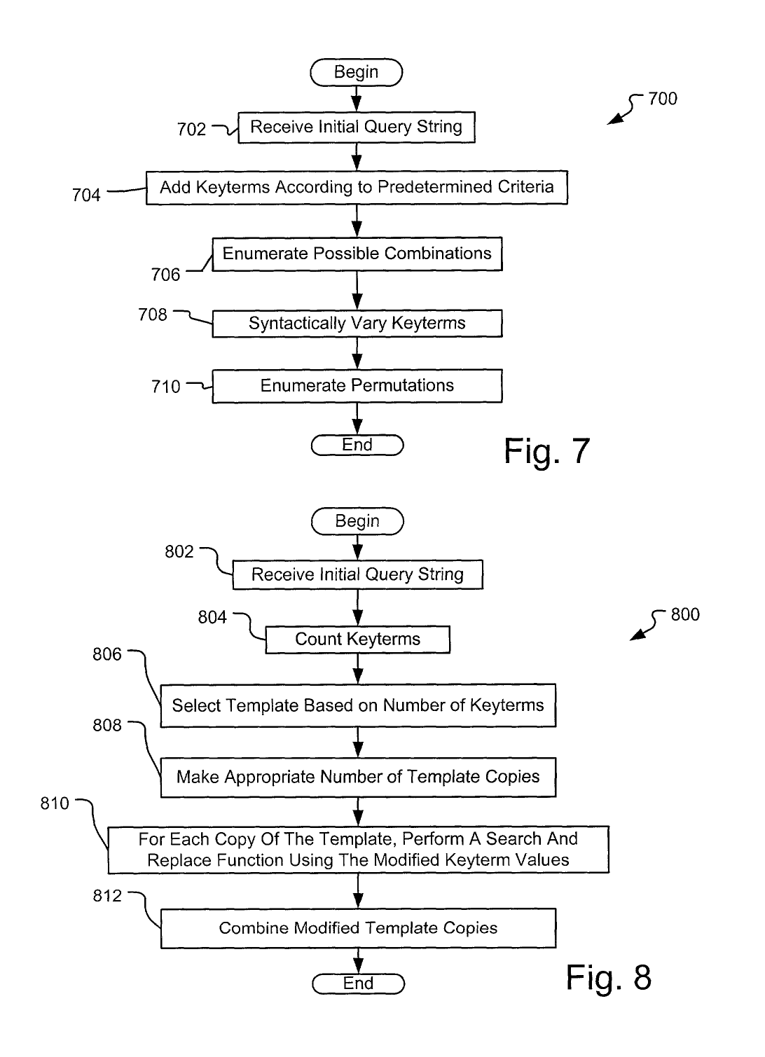

FIG. 7 illustrates the flow of operations in an embodiment of the present invention. Initially, receive operation 702 receives an initial input query. Once the query is received, add operation 704 adds keyterms based on a predetermined criteria. In this case, the predetermined criteria may be based on thesaurus addition rules, and/or based on stemming and/or duplication. Essentially, add operation increases the query list of terms with additional, relevant terms.

Following the addition of relevant terms, enumerate operation 706 enumerates the possible combinations of terms and other query elements, where the query elements relates to the original keyterms, the added thesaurus terms, the Boolean and proximity operators, and the parentheses. In this context, “combinations” relates to all subsets of any set S. As a special case, a combination might be the subset including all the members of the set S or none of the members of the set S, i.e., the null set. For the purposes of this patent, combinations will not refer to the null set. The arrangement of the members is not relevant to the identity of the combination. Moreover, the determination of possible combination elements may involve one, some or all of the possible modifications, i.e., adding thesaurus terms, adding terms based on stemming, etc.

Once all the combinations are enumerated, vary operation 708 syntactically varies the keyterms for the different combinations, which produces more combinations of terms. Syntactically varying keyterms may relate to the variations of case or the use of wildcards, etc. Typically, syntactic variation replaces keyterms with other, similar keyterms as opposed to simply adding more keyterms to the list.

Following the variations of the combinations based on syntactic rules, enumerate operation 710 enumerates all the possible permutations for all the possible combinations. In this context, “permutations” relate to the arrangement or order of the members of a set or combination. The set of enumerated permutations is the query matrix to be supplied to the autoloader.

In order to produce a meaningful query matrix, it may be helpful to determine the number possible unique queries that will be generated based on different addition or syntactic variation rules. Typically, the number of permutations that may be generated, for any set having n number of members, is n! (i.e., n factorial). The number of possible unique queries then, for any set S with n members is given by the following equation:

$$Number of possible Query = {\sum }_{p = 2}^{n} \frac{n !}{( n - p ) !} .$$

However, if each term is treated as either “present” or “absent”, the equation may be simplified to 2ⁿ⁻¹. Therefore, an example set containing six members would have (2⁶⁻¹) or 63 possible combinations.

The following two tables, Table 2 and Table 3 are provided as examples of the query generation process using thesaurus synonyms and case sensitivity as possible changes to the initial query string. The examples further illustrate the number of possible unique queries that may be generated based on these predetermined criteria for expanding and varying the initial query. That is, the example shown in Table 2 illustrates the approximate number of different queries based on a two word initial query, two additional thesaurus terms and varying the case sensitivity. To further the example, Table 3 illustrates the significant increase in queries that are generated by simply adding one more word to the original input query, e.g., “sled.”

| | | Resulting |
|---|---|---|
| | | Number of |
| Operation | Query Generation Process | Queries |
| 1 | “dog Manitoba” is received by the query matrix | 1 |
| | generator. | |
| 2 | Using the thesaurus keyterm addition rules, | 1 |
| | adding “puppy” and “canine” to the query. | |
| 3 | Determine all possible combinations for these | 15 |
| | four keyterms, (i.e., 2⁴ −1). | |
| 4 | Add syntactical variation, for example add new | 255 |
| | elements based on case sensitivity, wildcards, etc. | |
| | For the purposes of this example, consider only | |
| | case sensitivity wherein each keyterm may be | |
| | replaced by either of two additional variants (e.g., | |
| | “dog” with “Dog” or “DOG”). | |
| 5 | Enumerate all possible permutations for each | 2712 |
| | combination. | |

TABLE 3

| | | Resulting |
|---|---|---|
| | | Number of |
| Operation | Query Generation Process | Queries |
| 1 | “sled dog Manitoba” is received by the query | 1 |
| | matrix generator. | |
| 2 | Using the thesaurus keyterm addition rules, | 1 |
| | adding “puppy” and “canine” to the query. | |
| 3 | Determine all possible combinations for these | 31 |
| | four keyterms, (i.e., 2⁵ − 1). | |
| 4 | Add syntactical variation of case sensitivity. | 1023 |
| 5 | Enumerate all possible permutations for each | 40695 |
| | combination. | |

As shown in these examples, the number of queries may increase significantly by adding only a few new terms to the original query. Therefore, in some cases, it may be beneficial to modify the process shown in FIG. 7 slightly to generate a more manageable number of queries. Even more importantly, some search engines may not be sensitive to the same variations in terms, e.g., not all search engines are case sensitive, and therefore the process might be modified to account for these differences.

Table 4 below illustrates such a modification to the example shown in Table 2 but wherein the process flow is modified such that the act of adding syntactical variance based on case sensitivity occurs following the determination of the permutations.

TABLE 4

| | | Resulting |
|---|---|---|
| | | Number of |
| Operation | Query Generation Process | Queries |
| 1 | “dog Manitoba” is received by the query matrix | 1 |
| | generator. | |
| 2 | Using the thesaurus keyterm addition rules, | 1 |
| | adding “puppy” and “canine” to the query. | |
| 3 | Determine all possible combinations for these | 15 |
| | four keyterms, (i.e., 2⁴ - 1). | |
| 4 | Enumerate all possible permutations for each | 64 |
| | combination. | |
| 5 | Add syntactical variation of case sensitivity, here | 192 |
| | applying it in a global manner, i.e., applying it to | |
| | all the terms within a given permuted | |
| | combination. | |

The query set produced by the process shown in Table 4 would most likely only be supplied to search engines that are not sensitive to the numerous queries produced by the process illustrated in FIG. 7, and described in conjunction with Tables 2 and 3. That is, the predetermined restriction involved with the process described in conjunction with Table 4 is based on an understanding certain search engines are not sensitive to the many different queries that may be produced by the process shown in FIG. 7. Thus, to avoid redundant results, restrictions may be placed on the process.

Other restrictions that may be placed on the query generation process relate to the fact that ill-formed queries are not allowed. Such ill-formed queries may relate to nesting Boolean operators by themselves, which would not make sense. Another restriction relates to not using operators that the search engine will not recognize. For example, some search engines will not recognize the “OR” Boolean operator, such that generating queries using this operator would produce redundant results. Yet another restriction relates to explicit use of Boolean or Proximity operators in the original query. If such an explicit use occurs, the process does not produce queries that would contradict that explicit use.

While these restrictions may be provided by the end user prior to supplying the initial query, the matrix generator may also employ a restriction module that automatically restricts the query according to predetermined criteria. Such predetermined criteria may relate to the ill-formed query rules or the rules related to the explicit use of Boolean or Proximity operators. Yet other predetermined criteria may relate to specific search engines sensitivity. In the latter case, the restriction module may communicate with various search engines to determine their related sensitivities and store this information such that meaningful restrictions may be employed during the generation of the query matrix.

In order to enumerate different combinations of keyterms based on syntactical variations, the process shown in FIG. 8 may be employed. The process begins with receive operation 802 which receives the original query string. Following receive operation 802, count module 804 counts the number of keyterms in the query.

Once the keyterms have been counted, select operation 806 selects the corresponding template based on the number of keyterms in the query string. Templates may be stored in memory or generated according to a automatic method. Each template essentially comprises a query set having unique identifiers for each possible keyterm. For example, the template may use “xxxx” as one identifier and “yyyy” as another identifier.

Following the selection of the template, copy operation 808 generates the appropriate number of copies of the template and stores each copy in a file. The appropriate number of copies relates to the type of variance that is to be applied to the original query set. For example, if the variance is related to case sensitivity and the resulting query set is to have three types of case sensitive elements (e.g., all lowercase, all uppercase, and first letter uppercase) then copy operation creates three copies of the template.

Following copy operation 810, search and replace operation 812 performs a search and replace function on each template, replacing the unique identifier with a variant of the original keyterm. This operation effectively populates each copy of the template with unique query sets based on the predetermined variant, e.g. case sensitivity.

Once the various copies of the templates have been populated with keyterms by search and replace operation 810, combine operation 812 combines the various copies into one file, i.e., the enumerated combinations.

The process shown in FIG. 8 may also be used to generate query sets based on permutations. In an alternative embodiment, the following Perl script may be implemented to generate a matrix based on word order, e.g., permutations:

open (WRITE, “>autoload. txt”) || die “Couldn't opent $!”;
@matrix1 = <READ1>;
@matrix2 = <READ2>;
@matrix3 = <READ3>;
while (<READ>) {

foreach $e1 (@matrix1) {

foreach $e2 (@matrix2) {

foreach $e3 (@matrix3) {

$_{—} =˜ s/ \n/ /gs;
$_e1 =˜ s/ \n/ /gs;
$_e2 =˜ s/ \n/ /gs;
print WRITE $_, $e1, $e2, $e3;
print $_, $e1, $e2, $e3;

}

}

}

}
close WRITE;
close READ;
close READ1;
close READ2;

The code section described above effectively creates a matrix of queries wherein the differences between the queries is based on the order of the key terms. Other similar code sections may be used to create multiple queries having differences based on capitalization, stemming or other differences. Moreover, a combination of these different code sections may be used to create an even larger matrix of queries.

A significant benefit derived from the present invention relates to the fact that a large number of queries are automatically loaded into different search resources available on the Web. Manual entry of such a large number of queries would be extremely time consuming, if not impossible. Furthermore because each search resource searches a different group of web documents for its information, the scope of the web documents searched by the present invention is greater than other search resources.

In addition, the constrained content approach (i.e., filtering the full-text pages) removes a very large portion of the processing burden from the information retrieval internal system, placing it instead on an exogenous filter system. Additionally the reduced number of entries, and the tighter linguistic and topical focus of the entries, allows for specialized and more efficient processing functions.

In addition to advantages already discussed for discovery, collection and storage topical differentiation also has important advantages in the areas of information organization, refinement, and presentation. The system may take advantage of “natural” or common usage methods for organizing collected information derived from the topic area itself. Further, the specialized uses of language often associated with specific topics can be used by this system as guides and markers to refine and differentiate topical groupings. In comparison, for global systems that must integrate many or all subjects or topics, this specialized usage is a significant contributor to the noise and imprecision within the process. In addition, the use of a topical format lends itself readily to thematic graphical and design expression for display and presentation within the context of the specific topic. In summary, the present invention searches more web documents (allowing for a larger database) and adds to the topical database only those documents that satisfy the filters topical criteria (allowing for a more relevant database). In other words, the present invention not only generates more information, it also generates more relevant information.

Yet another advantage to the present method of collecting topically related resources relates the ability to further analyze the collection of resources. For example, a topical email list may be generated based on the collection of topically related resources. That is, since many resources, including articles, white papers, etc., include the author's email address, these email addresses may be compiled into yet another topically related resource. The topically related email resource may then be used by an end user for multiple purposes, including generation of topical discussion groups or marketing materials.

The invention disclosed here is distinct from prior teaching within this field in that it automatically loads queries into the search resources, resulting in a substantial and useful change in the processing profile and capabilities for large scale Web or Internet search resources.

Another aspect of this system is the ability to control the degree of precision used to select or reject pages or documents. This is accomplished by selecting the degree of precision of the linguistic signature applied, and by the stringency of conformity required for acceptance.

Significant advantages are gained from a system using a data set that has been filtered or constrained during the discovery and collection process. The purpose of this approach is to insulate and protect the system from the burden of undifferentiated data sets. This method reduces the number of instances that the information retrieval system must process, prior to its being exposed to them. This approach also narrows and focuses the range of operations required of the information retrieval system through the imposition of a topic, class, category or subject limitation. These modifications from standard search practice serve to substantially reduce the processing overhead and burden, allowing for substantial improvement in performance.

The present invention is the method, apparatus, computer storage medium or propagated signal containing a computer program for providing a discovery and collection system for collecting topically related resources and creating a topical database as recited within the claimed attached hereto. Thus the present invention is presently embodied as a method, apparatus, computer-storage medium or propagated signal containing a computer program for traversing the Web, analyzing sites and/or documents and delivering only relevant documents to a database. While the invention has been particularly shown and described with reference to preferred embodiments thereof, it will be understood by those skilled in the art that various other changes in the form and details may be made therein without departing form the spirit and scope of the invention.

What is claimed is:

1. A method of creating a topical data structure of information located on an inter-linked system of informational documents, the method comprising:
receiving an input query of keywords;
generating a query matrix using the input query wherein the query matrix comprises a set of unique queries having keyterms, wherein the keyterms are related to the keywords supplied with the input query; and
automatically searching a plurality of queriable databases using the query matrix to obtain a result; and
loading the result into a topical data structure.

2. A method as defined in claim 1 wherein the act of generating a query matrix comprises:
adding keyterms according to predetermined criteria; and
enumerating possible combinations based on the initial keywords and then added keyterms.

3. A method as defined in claim 2 further comprising:
syntactically varying the keyterms; and
enumerating possible permutations based on the syntactical variations.

4. A method as defined in claim 2 wherein the predetermined criteria relates to thesaurus keyterms.

5. A method as defined in claim 4 wherein act of adding keyterms comprises automatically entering thesaurus keyterms from a lookup table to the query.

6. A method as defined in claim 4 wherein the act of adding keyterms comprises:
providing a list of possible thesaurus keyterms for selection;
selecting at least one keyterm from the provided list; and
adding the selected keyterm to the query.

7. A method as defined in claim 2 wherein the predetermined criteria relates to stemming.

8. A method as defined in claim 2 wherein the predetermined criteria relates to duplication.

9. A method as defined in claim 3 wherein the syntactical variation is based on case sensitivity.

10. A method as defined in claim 3 wherein the syntactical variation employs the use of wildcards.

11. A method as defined in claim 3 wherein the act of enumerating permutations further comprises:
creating a template text document;
assigning each keyword of then input query to an element of the template document; and
performing a search and replace function on the template document with the keyword elements.

12. A method as defined in claim 11 wherein the act of creating a template document further comprises:
counting keyterms in a query set; and
choosing a predefined template based on the number of keyterms.

13. A discovery and collection system for analyzing documents found on an inter-linked system of documents, the discovery and collection system providing topically related documents to an information retrieval system having a searchable data structure, the searchable data structure providing users document information in response to user supplied queries, said discovery and collection system comprising:
a query interface;
a matrix generator for automatically creating a set of unique query keyterm combinations in response to receiving an initial query from the query interface; and
an autoloader for loading the keyterm combinations into a queriable database, the queriable database returning results to the searchable data structure related to the keyterm combination entered.

14. A system as defined in claim 13 wherein the matrix generator comprises:
a keyterm adding module that adds keyterms to the initial query to create a plurality of unique queries; and
a syntactical variance module that modifies keyterms in the plurality of unique queries.

15. A system as defined in claim 14 further comprising:
a restriction module for limiting the number of queries in accordance with predetermined criteria.

16. A system as defined in claim 15 wherein the predetermined criteria relates to ill-formed queries.

17. A system as defined in claim 15 wherein the predetermined criteria relates to restricting queries that contradict explicit uses of operators.

18. A system as defined in claim 15 wherein the predetermined criteria relates to sensitivities of a search engine.

19. A system as defined in claim 14 wherein the initial query comprises keyterms having synonyms and the keyterm adding module automatically adds at least one synonym to the query.

20. A system as defined in claim 14 wherein the keyterm adding module adds keyterms to the query based on stemming.

21. A system as defined in claim 14 wherein the syntactical variation module varies keyterms based on at least one of the following: case sensitivity, wild cards, keyterm order, Boolean relations, proximity relations, or parenthetical nesting.

22. A computer program product readable by a computer and encoding instructions for executing a computer process for creating a topical data structure, said process comprising:
receiving an input query of keywords;
generating a query matrix using the input query wherein the query matrix comprises a set of unique queries having keyterms, wherein the keyterms are related to the keywords supplied with the input query; and
automatically searching a plurality of queriable databases using the query matrix to obtain a result; and
loading the result into a topical data structure.

23. A computer program product as defined in claim 22 wherein the process act of creating a template document further comprises:
adding keyterms according to predetermined criteria;
enumerating possible combinations based on the initial keywords and then added keyterms;
syntactically varying the keyterms; and
enumerating possible permutations based on the syntactical variations.

24. A computer program product as defined in claim 23 wherein the predetermined criteria relates to thesaurus keyterms.

25. A computer program product as defined in claim 24 wherein act of adding keyterms comprises automatically entering thesaurus keyterms from a lookup table to the query.

26. A computer program product as defined in claim 24 wherein the act of adding keyterms comprises:
providing a list of possible thesaurus keyterms for selection;
selecting at least one keyterm from the provided list; and
adding the selected keyterm to the query.

27. A computer program product as defined in claim 23 wherein the predetermined criteria relates to stemming.

28. A computer program product as defined in claim 23 wherein the predetermined criteria relates to duplication.

29. A computer program product as defined in claim 23 wherein the syntactical variation is based on case sensitivity.

30. A computer program product as defined in claim 23 wherein the syntactical variation employs the use of wildcards.

31. A computer program product as defined in claim 23 wherein the act of enumerating permutations further comprises:
creating a template text document;
assigning each keyword of then input query to an element of the template document; and
performing a search and replace function on the template document with the keyword elements.

32. A computer program product as defined in claim 31 wherein the act of creating a template document further comprises:
counting keyterms in a query set; and
choosing a predefined template based on the number of keyterms.

33. A computer program product as defined in claim 23 wherein the process further comprises:
restricting the query matrix according to predetermined restricting criteria, wherein the predetermined restricting criteria is related to at least one of the following: ill formed queries, explicit use of operators, or search engine sensitivities.
